(19) United States
(12) Patent Application Publication
(10) Pub. No.: US 2011/0024062 A1
(43) Pub. Date: Feb. 3, 2011

(54) Roller Shutter Curtain Sectional Slat with Thermal Insulation, Manufacturing Method Therefor, and Roller Shutter Equipped Therewith

(75) Inventor: Stephan Hörmann, Gutersloh (DE)

Correspondence Address: GLOBAL IP COUNSELORS, LLP, 1233 20TH STREET, NW, SUITE 700, WASHINGTON, DC, 20036-2680, US

(73) Assignee: HORMANN KG DISSEN, Dissen (DE)

(21) Appl. No.: 12/446,145

(22) PCT Filed: Oct. 16, 2007
(86) PCT No.: PCT/EP07/60999

§ 371 Date: Oct. 19, 2010

(30) Foreign Application Priority Data
Oct. 17, 2006 (DE) 10 2006 048 996.6
Oct. 26, 2006 (DE) 10 2006 050 596.4

(51) Int. Cl. E06B 9/42; B32B 37/02; B32B 38/00; B29C 65/00; A47H 23/00

(52) U.S. Cl. 160/236; 156/79; 156/227; 160/238

(57) ABSTRACT

A roller shutter curtain sectional slat is provided with thermal insulation between an inside and an outside. For this purpose, the sectional slat preferably has two panel elements only connected with each other by an intermediate element of poorer thermal conductance than the material of the panel elements. Hinge profile areas are only present on one of the two panel elements. Moreover, a roller shutter curtain is made of such sectional slats and a roller shutter equipped therewith.

The present invention relates to a sectional slat for a roller shutter curtain. The invention further relates to a method for manufacturing such a sectional slat. Further, the present invention relates to a roller shutter curtain consisting of a plurality of such sectional slats, and a roller shutter equipped therewith.

Roller shutters have been known for many decades and have proven useful, in particular, for closing off the gateways of commercial buildings and industrial buildings. Roller shutters usually have a motor-driven barrel onto which a curtain, which serves to close off the wall opening, can be wound. The curtain is guided in guide rails at the side of the wall opening. The barrel is usually rotatably supported on suitable bearing means in the area of the lintel of the wall opening. Roller shutters have the advantage, among others, that they need only relatively little space in the lintel area in the opened state. The space behind this lintel area can still be used to its full height.

In the type of roller shutters in question, the curtain is formed by a so-called roller shutter curtain, formed of a series of hinged sectional slats. Well-know roller shutter curtains, as they are commercially available from Hörmann KG, amongst others, and shown in the company brochure “Roller Shutters and Roller Grids” of Hörmann KG Verkausfgesellschaft, March 2006, have sectional slats of metal.

These sectional slats have hinge profile areas at their long edges, with which adjacent sectional slats are in hooked engagement with each other in such a way that they are pivotable relative to each other for winding up a roller shutter curtain. For this purpose the surfaces of the sectional slats forming the outside or the inside of the roller shutter curtain are brought together at their long edges and unified in a hook-shaped hinge profile. In this way, the hinge profile has a construction robust enough to withstand the weight load exerted by the hanging roller shutter curtain. In the present context it should be noted that the roller shutter sectional slats situated at the top of the closed roller shutter must bear the entire weight of the roller shutter sectional slats hanging therefrom and extending downwards. The hinge profile areas in hook-engagement with each other must therefore be formed with corresponding strength.

Although such roller shutters have proven useful, there is an urgent desire in view of the energy cost which has soared in the recent past, and in view of environmental issues, to improve the heat insulating ability of such roller shutters with roller shutter curtains.

To solve this object, according to the present invention, a roller shutter sectional slat is suggested with thermal insulation.

In particular, for a sectional slat of a roller shutter curtain, wherein the sectional slat has a first panel element, a second panel element and at least one intermediate element between the two panel elements, wherein the material of the at least one intermediate element—in particular for insulating purposes—is less robust and has poorer thermal conductivity with respect to the material or the materials of the panel elements, it is suggested, that on a first long edge of only one of the panel elements, a first hinge profile area, and on a second long edge opposed to the first long edge of the same panel element, a second hinge profile area is formed for hinging adjacent identical sectional slats. Advantageously, it is further suggested that the panel elements are only connected via the at least one intermediate element and therefore thermally insulated from each other.

According to the present invention, there are no more heat conductors between the panel elements forming the inside and the outside of the roller shutter curtain.

The weight forces are essentially transferred through the roller shutter sectional slat via the single panel element on which both a top and a bottom hinge profile area is formed. This panel element is made rigid by the intermediate element and the other panel element, so that the panel element can also be made of thin materials.

Even though not insignificant forces can be transmitted via the roller shutter sectional slat, the roller shutter sectional slat can dispense with metallic connections or any other connections with good heat conduction between the inside and the outside.

A roller shutter curtain formed of such roller shutter sectional slats, and a roller shutter equipped therewith, and a manufacturing method for the roller shutter sectional slats are the subject matter of the independent claims.

Advantageous embodiments of the invention are the subject of the dependent claims.

Although the panel elements can also be elements arranged further to the inside, so that outer covering layers can also be present, it is preferred for both optical and static reasons that the panel elements are always configured to form a corresponding portion of the outside or inside of the eventual roller shutter curtain.

Preferably, the hinge profile areas are present on that panel element which is closer to the barrel when it is wound on the barrel.

The tensile force of the roller shutter curtain is thus effective closer to the rotary axis of the barrel so that a smaller torque is to be exerted.

In most roller shutters—excepting the so-called external roller shutters, c.f. the above mentioned Hermann company brochure—this panel element will be the panel element for forming the inside of the roller shutter curtain, which will be referred to as the “first panel element” in the following. As basically known with conventional roller shutter curtain sectional slats, the hinge profile areas for hooked engagement are preferably formed in a hook shape in a manner complementary to each other. For formation of the hinge solely by means of the hinge profile areas hooked within each other without additional pins or the like, it is preferably provided that at least one of the hinge profile areas is at least partially formed in a circular arc shape.

Metal sheeting, in particular steel sheeting, is preferably used as the material for the panel elements. Alternatively, one or both of the panel elements could also be of a light metal, formed, for example, by an extrusion method.

For reinforcing the hinge profile areas subject to particular loads, it is preferably provided that at least one of the hinge profile areas, preferably both hinge profile areas, are formed with an increased wall thickness. For forming an increased wall thickness of the hinge profile areas with respect to an intermediate area connecting these hinge profile areas of the panel element comprising the hinge profile areas, the panel element can be extruded with a corresponding section. Another possibility to achieve increased wall thickness in the hinge profile areas consists in forming the corresponding panel element of metal sheeting having variable thickness. This can be achieved by rolling out a metal sheet with narrow rollers, so that a central intermediate area is thinner than the edge areas. A simpler method of forming the hinge profile areas with greater wall thickness consists in forming these hinge profile areas of at least two layers of metal sheeting. This can be achieved, in particular, when forming them of steel sheet, by folding back a sheet strip, of which the first panel element is formed, at its long edges at least once.

In its remaining area—in particular the intermediate area—the first panel element is then preferably thinner than in the hinge profile areas. The hinge profile areas are thus selectively formed in a reinforced manner, wherein material is economized in those areas which are subject to smaller loads. Due to this selective use of metal sheeting of variable thickness or of a plurality of layers in the hinge profile areas, the first panel element comprising the hinge profile areas can be made thinner than the second panel element, which will later be used on the outside. Damage to a roller shutter curtain is to be primarily expected on the outside rather than on the inside. It is therefore preferable to form the entire outside of thicker materials so that greater resistance against external forces is achieved. The first panel element forming the inside can then have as little as half the thickness to economize material.

It is preferred, however, that the two panel elements have comparable bending stiffness so that they bend by about the same amount under bending loads and there is no warping on the intermediate element connecting the two panel elements.

Due to the thickness of the two panel elements, bending of a roller shutter slat can generally be adjusted under the application of a load. This adjustment should preferably be made such that the neutral phase of the bend is as far in the centre as possible to achieve the best possible distribution of relative displacements of the individual elements of the sectional slat so that no individual relative displacement becomes unacceptably large.

If the bending strength is different and one of the panel elements is moved by too large an amount relative to the intermediate element when the sectional slat is bent, the material of the intermediate element could detach from one of the panel elements. The bending strength is a function of the thickness of the panel element; in particular, it is about proportional to the third power of the thickness. Therefore, if a double metal sheet layer or double the thickness is used for the hinge profile areas, the surface material of the first panel element can be thinner by a factor of about 1.26 (third power of 2).

Further stiffening can be achieved by joining the folded sheet layers to each other. This should be done at least at a plurality of places; best results are achieved by surface joining, such as with adhesive gluing.

The second panel element can basically consist of a uniformly thick metal layer; to reinforce the again particularly stressed edge areas it can also be provided in this case that the edge areas are formed of thicker material or in several layers, for example, folded back.

The intermediate element is preferably of an insulating material. Particularly preferably, the intermediate element is at least partially of foamed material, in particular of PU hard foam. Preferably, a particularly heavy gas is in the foamed material pores. The heavier the gas molecules, the less they are heat conducting. The foamed material of the intermediate element is foamed, for example, with such a gas. Carbon dioxide is particularly suitable for this purpose. To be able to hold the heavy gas within the foamed material, the foamed material is preferably enclosed in a gas-tight manner on as much of the surface as possible. The two panel elements serve this purpose on two sides. To be able to achieve a gas barrier also on the long edges, it is preferable to provide a diffusion-tight barrier on the exposed surfaces of the intermediate element. This barrier is preferably formed in such a way that it is impermeable to carbon dioxide. Particularly preferably, a water vapor barrier is provided, for example a water vapor diffusion-tight coating or other layer. To ensure a defined distance between the panel elements and therefore a defined thickness of the sectional slat during manufacture and foaming, it is further preferred that the intermediate element comprises at least one sectional rib as a spacer between the panel elements. The at least one sectional rib can also fulfill the function of the above-mentioned gas-tight barrier and can be formed as a gas barrier.

To be able to provide a selection of different lengths of sectional slats from a manufacturing point of view in the simplest possible manner and without or with little wastage, preferably a plurality of short sectional ribs are combined in their longitudinal direction in sequence to form a sectional rib arrangement. Depending on the length of the final sectional slat, one, two, three etc. will be combined in a sectional rib arrangement, which comes as close as possible to the length of the sectional slat. Further, as a gas barrier, preferably two such sectional rib arrangements are inserted between the panel elements in a spaced relationship, wherein the gap between the sectional rib arrangements is filled with foamed material. The sectional ribs are preferably of a material having poor heat conducting properties. Preferably, the sectional ribs used are of a plastic material, in particular polystyrene or polysterol.

The intermediate element can be prefabricated as a pad and subsequently joined with the two panel elements. For this purpose, the prefabricated intermediate element is inserted and preferably adhesively joined, in particular adhesively glued. The prefabricated embodiment of the intermediate element can comprise an individual hard foam pad. Preferably, the prefabricated intermediate element is precoated with the above described diffusion-tight coating in the areas not joined to the panel elements. Instead of a pad of a continuous homogeneous material, a pad could also be provided having varying properties across its thickness, in particular having varying stiffness across the thickness. An integral foamed pad is used, for example, which is softer on the sides to be joined to the panel elements than in its interior. The highest strength is preferably about central. If the intermediate element has its greatest stiffness at about the center between the two panel elements, it is unlikely during bending of the sectional slat that one of the panel elements is more strongly displaced relative to the intermediate element. Any relative displacement of areas of the intermediate element can be better compensated by making the intermediate element softer in the joint area between the panel and intermediate element. It is also conceivable to make the intermediate element of a composite material to achieve the desired properties. It is desirable, in particular, for the intermediate element that it stiffens the roller shutter sectional slat against bending. Furthermore, the intermediate element should serve for thermal insulation, and finally the intermediate element should be constructed in such a manner that detachment, if only partially, of the intermediate element from one of the panel elements is avoided as far as possible. Moreover, the intermediate element should also conserve its properties, in particular its heat insulating properties, over a longer period of time.

To fix the foamed material on the panel elements, the panel elements also preferably have protrusions extending toward the foamed material, which are in positive engagement with the foamed material in the finished sectional slat.

The sectional slats are linkable at their hinge profile areas in a manner pivotable with respect to each other. This is how a roller shutter curtain windable on a barrel is created by a series of linked sectional slats, wherein the inside and the outside of the curtain are thermally insulated from each other. A roller shutter formed with such a roller shutter curtain is distinguished, in particular, by increased heat insulation values without drawbacks for the manufacture or strength.

In an advantageous method for manufacturing a roller shutter sectional slat according to the present invention, at first, the first panel element is provided with the hinge profile areas. To achieve this, advantageously, first of all an elongate metal sheet is used having its long edge areas initially formed thicker or folded back, so that thicker or multi-layer edge areas result on the long edges of the metal sheet. These thicker or multi-layer edge areas are then formed in such a way that hook-shaped hinge profile areas are formed. On the thus created first panel element, two sectional rib arrangements are mounted on that side which should later face toward the inside of the roller shutter sectional slat. Preferably, the sectional rib arrangements are formed of a plurality of shorter sectional ribs closely spaced one after the other in their longitudinal direction. Then the foamed plastic raw material in the unfoamed state will be inserted in the space between the sectional rib arrangements. The space is then covered with the second panel element. Then the foamable mass is foamed, wherein a counter pressure is exerted from the outside on a large surface of the two panel elements so that these panel elements do not warp toward the outside but maintain their form.

The second panel element could be made of thicker metal sheeting. For stiffening, however, only the long edge areas of an elongate metal sheet could be made thicker or folded back to thus form the second panel element.

Instead of manufacture by means of filling with foam, the manufacturing method already mentioned above could also be implemented, wherein the two panel elements are prefabricated, as mentioned above, and the intermediate element is completely prefabricated as a pad or slat, and then the intermediate element is inserted between the panel elements and preferably adhesively joined to the panel elements.

The gap between two adjacent sectional slats can advantageously be sealed by inserting a seal, for example on the second panel element. As an alternative or in addition, a sealing material, such as a foamed plastic, more particularly a softer foamed plastic can be also inserted.

Exemplary embodiments of the invention will be explained in more detail in the following with reference to the accompanying drawings, wherein:

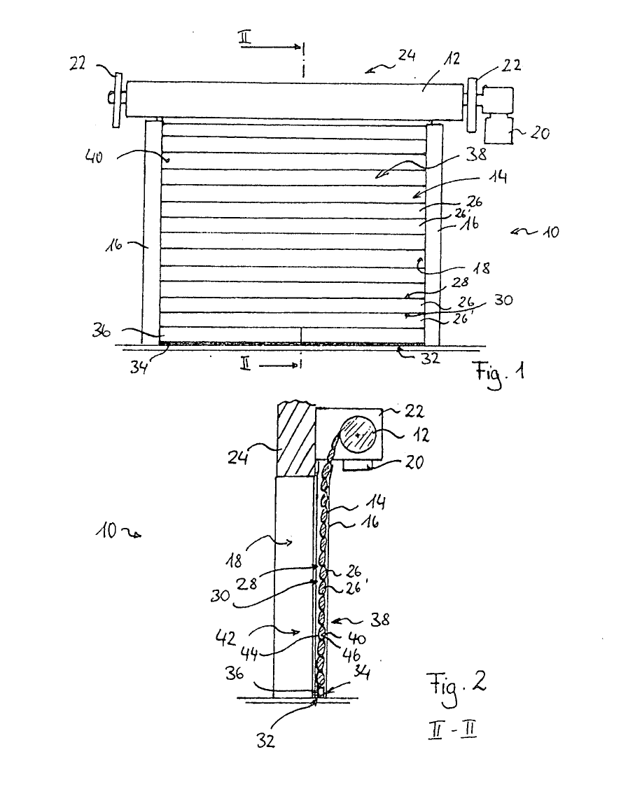

FIG. 1 shows an interior view of a roller shutter having a roller shutter curtain formed of sectional slats;

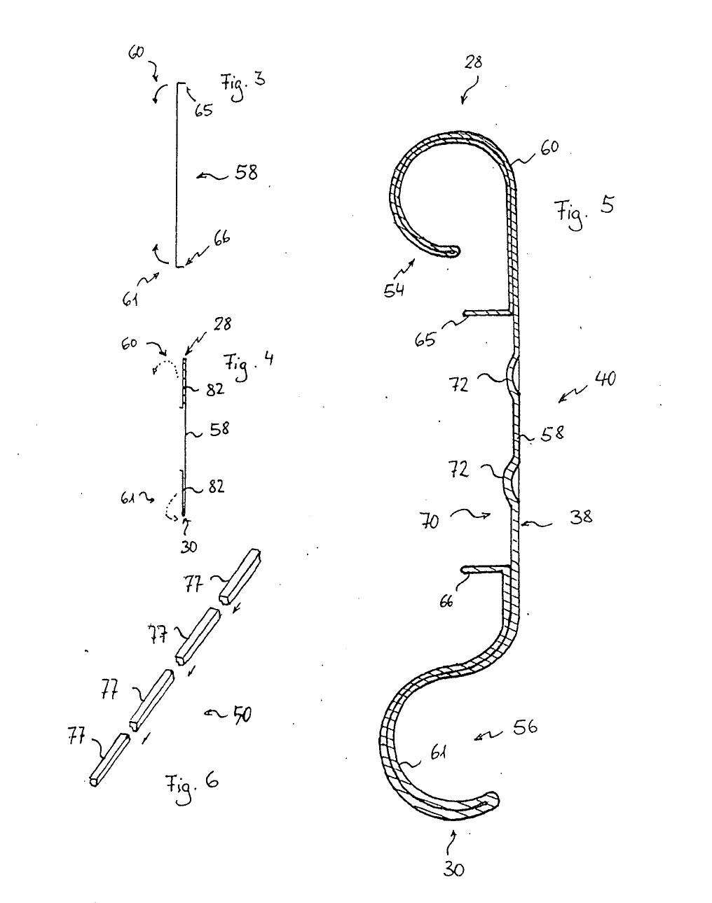

FIG. 2 is a sectional view of the roller shutter along line II-II of FIG. 1;

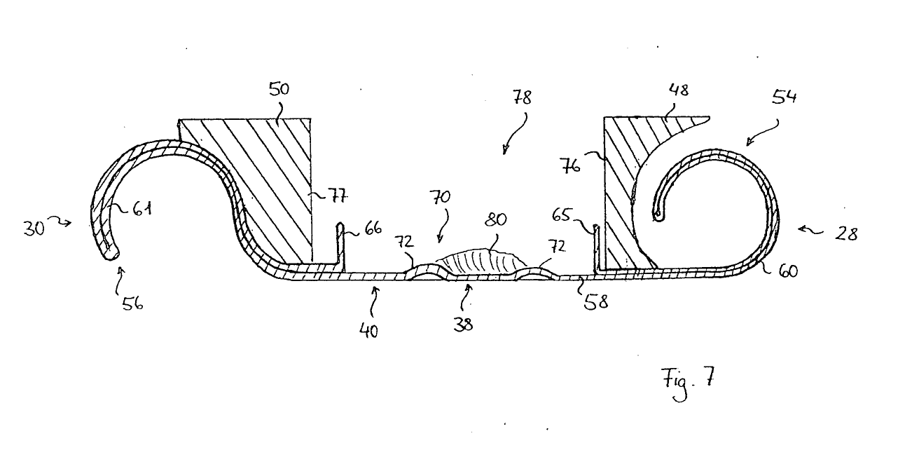

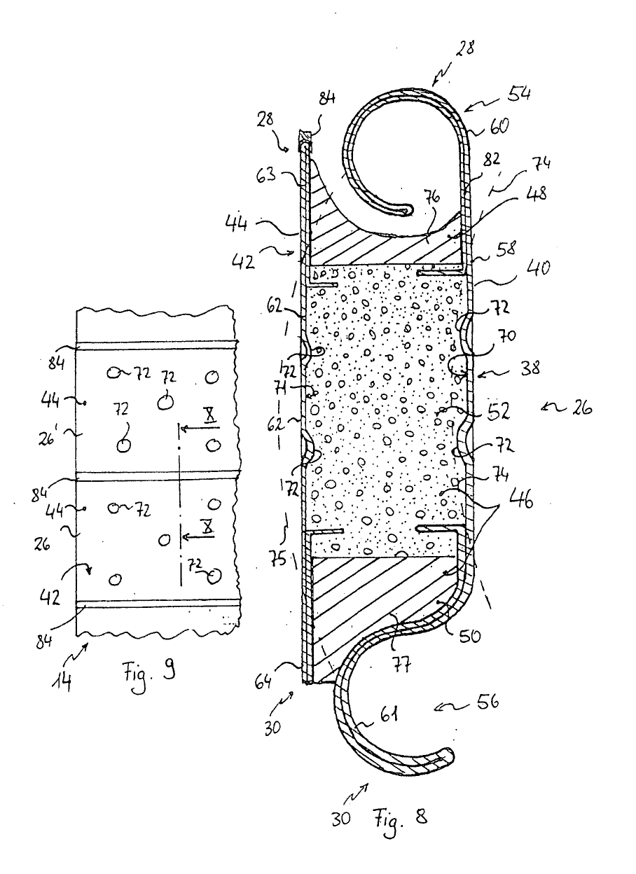

FIG. 3 is a schematic side view of a metal sheet for illustrating a first step in the manufacture of a sectional slat of the roller shutter;

FIG. 4 shows the metal sheet of FIG. 3 in a second step of the manufacturing method;

FIG. 5 is a sectional view of a first panel element of the roller shutter sectional slat manufactured from the metal sheet of FIGS. 3 and 4;

FIG. 6 is a perspective view of a sectional rib arrangement;

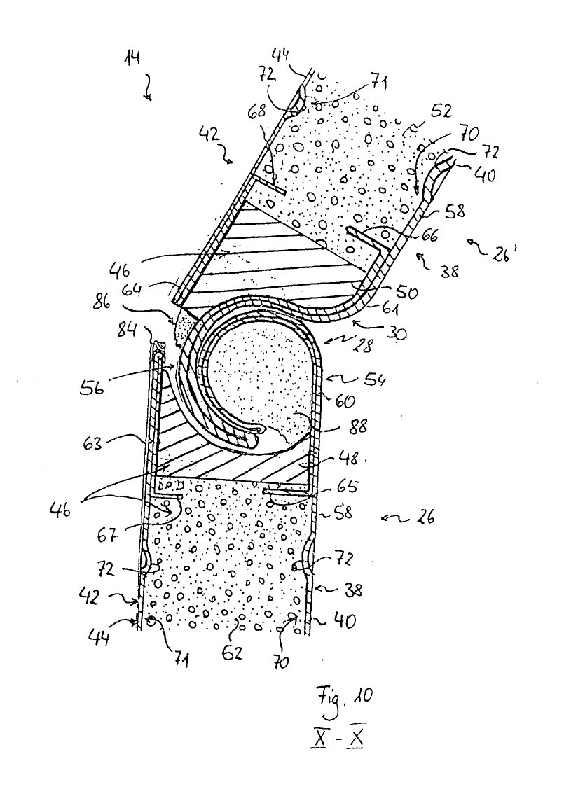

FIG. 7 is a sectional view of the panel element of FIG. 5 with two sectional rib arrangements and a foamable mass for illustrating a further intermediate step in the manufacture of the sectional slat;

FIG. 8 is a sectional view of the finished sectional slat for forming the roller shutter curtain of FIG. 1;

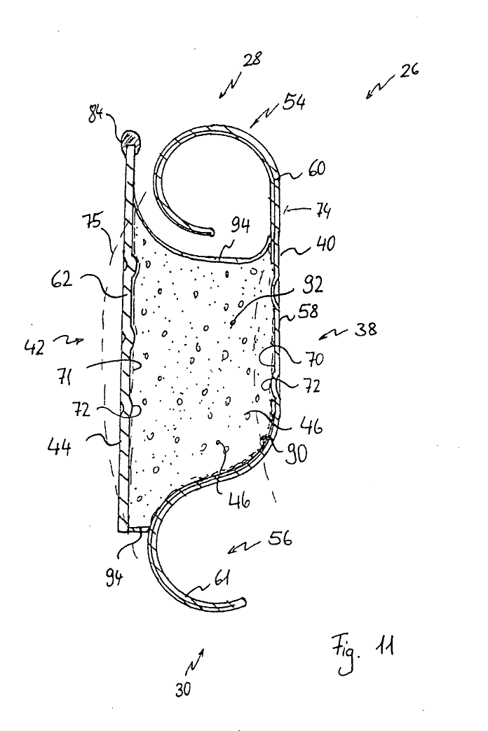

FIG. 9 is a plan view of an outer edge area of the roller shutter curtain formed of the roller shutter sectional slats according to FIG. 8;

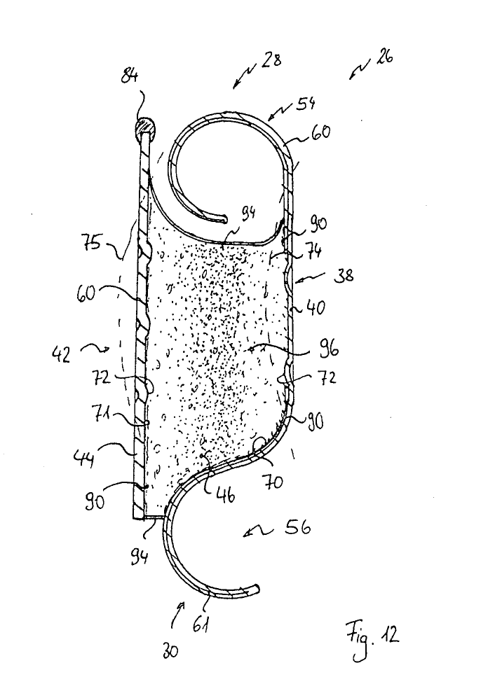

FIG. 10 is a section along line X-X of FIG. 9, wherein two adjacent sectional slats are shown in an angled relationship to each other in the view of FIG. 10;

FIGS. 11-13 are sectional views comparable to the one of FIG. 8 of the finished sectional slat in three further exemplary embodiments;

FIG. 14 is a view comparable to that of FIG. 5 of a further embodiment of the first panel element of a roller shutter sectional slat;

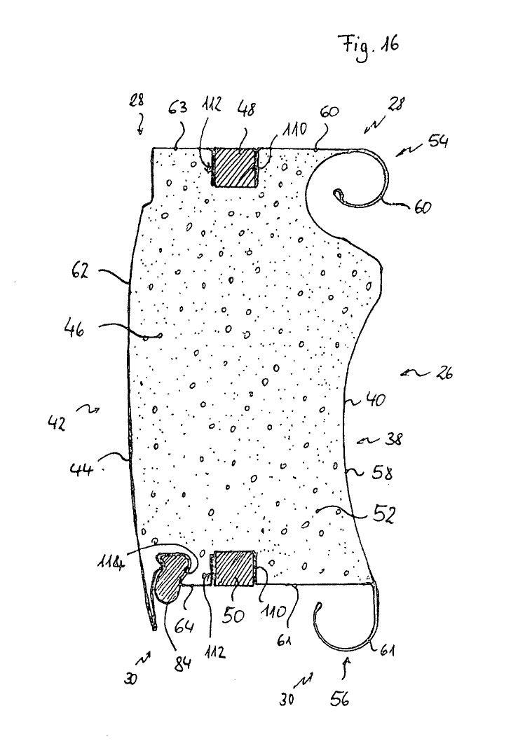

FIG. 15 is a sectional view of a further embodiment of the second panel element; and

FIG. 16 is a sectional view comparable to the one of FIG. 8 of the finished sectional slat in still a further exemplary embodiment.

FIGS. 1 and 2 show a roller shutter 10 in a closed position. Roller shutter 10 has a barrel 12 and a roller shutter curtain 14, which closes wall opening 18, guided in guide rails 16 and is windable on barrel 12 for opening roller shutter 10. For this purpose, barrel 12 is rotatably supported in the area of lintel 24 and drivable on support brackets 22 by means of a motor drive unit 20.

Roller shutter curtain 14 comprises a series of elongate sectional slats 26 hinged with respect to each other at their long edges 28, 30. The bottom end of a roller shutter curtain 14 is formed by a sectional bottom rail 36 forming the closure edge 32 with a closure edge securing means 34, formed differently from sectional slats 26. The top-most section can also be different from the remaining sectional slats 26; otherwise sectional slats 26 are identical to each other.

These sectional slats 26 are shown in FIGS. 1 and 2 in a purely schematic manner. A more detailed view of each of these sectional slats 26 is shown in FIG. 8 in a sectional view. FIG. 9 shows two adjacent sectional slats 26 and 26′, which are hinged to each other.

As can be seen from FIGS. 8 and 9, each sectional slat 26, 26′ comprises a first panel element 40 forming part of the inside 38 and a second panel element 44 forming part of the outside 42. The two panel elements 40, 44 are of metal, of steel sheet in the example shown. Panel elements 40, 44 are not joined to each other in a metallurgical manner, but are only joined by an intermediate element 46 entirely made of materials having poorer heat conductance than the materials of panel elements 40, 44 in the example shown.

Intermediate element 46, in the embodiment shown, has a first sectional rib arrangement 48 and a second sectional rib arrangement 50, and a (hard) foamed material 42 between sectional rib arrangements 48, 50. To be able to hinge sectional slats 26, 26′ to each other, the panel element which comes closer to the axis of barrel 12 when it is wound up, here first panel element 40 forming the inside 38, has a first hinge profile area 54 at its first long edge 28 and a second hinge profile area 56 at its second long edge 30. Hinge profile areas 54, 56 have, for example, a hook shape complementary to each other, so that the hook shape of second hinge profile area 56 of one sectional slat 26 can engage first hinge profile area 54 of adjacent sectional slat 26′. Hinge profile areas 54, 56 can thus form a hinge structure without any further additional elements. For forming hinge profile areas 54, 56, a first metal sheet 58, from which first panel element 40 is formed, is folded at its edge areas 60, 61, so that hinge profile areas 54, 56 are formed by at least a double layer of metal sheet.

Second panel element 44, in an embodiment not shown here, is formed by a single-layer second metal sheet 62. In the example shown, second metal sheet 62, which forms second panel element 44, is also folded at its edge areas 63, 64 in the area of long edge 28, 30.

Edge areas 60, 61, 63, 64 of metal sheets 58, 62 are provided with folds 65 to 68. The two panel elements 40, 44 are provided with bosses 72 at their surfaces 70, 71 facing intermediate element 46. Bosses 72, in the example shown, are formed by dot-shaped indentations from inside 38 or outside 42, respectively.

To simplify illustration, panel elements 40, 44, and roller shutter sectional slats 26, 26′ are shown with flat outsides 42 and insides 38, respectively. To be able to wind sectional slats 26, 26′ on the barrel without points of stress, the sectional slats 26, 26′ and panel elements 40, 42 are in practice, however, curved in an arc shape as indicated by broken lines 74, 75.

A method for manufacturing sectional slats 26, 26′ with thermal insulation will be explained in more detail in the following with reference to FIGS. 3 to 10. FIG. 3 shows a side view of first metal sheet 58. First metal sheet 58, in correspondence to the elongate form of final sectional slats 26, 26′ (c.f. FIG. 1) is in the form of an elongate metal sheet strip. Folds 65, 66 are first formed at the two long edges 28 and 30. In an embodiment which is not shown, these folds 65, 66 are omitted. Then edge areas 60, 61 are folded back. The metal sheet with the folded-back edge areas 60, 61 is shown in FIG. 4. On edge areas 60, 61 formed in plural layers, subsequently, forming using a cold forming method is carried out with the aid of corresponding sets of rollers, so that the two hinge profile areas 54, 56 are formed. Preferably prior to this forming, bosses 72 are also formed on first metal sheet 58 as shown in FIG. 4.

As shown in FIG. 6, taking second sectional rib arrangement 50 as an example, first and second sectional rib arrangement 48, 50 are formed of a plurality of sectional ribs 76, 77. Sectional rib arrangements 48, 50 are then mounted, preferably adhesively glued, to inner surface 70 facing the interior of sectional slat 26, 26′. Sectional ribs 76, 77 of first sectional rib arrangement 48 and second sectional rib arrangement 50, respectively, are formed in correspondence to the function of each hinge profile area 54, 56. In the space formed between sectional rib arrangements 48, 50 a foamable mass 80 is inserted for producing foamed material 52. Second panel element 44 is placed on sectional rib arrangements 48, 50 as a lid, whereupon foamable mass 80 foams. Inside 38 and outside 42 of the two panel elements 40, 44 have corresponding counter pressure plates applied to them during the foaming process, to avoid warping toward the outside of panel elements 40, 44 due to the foam pressure. After foaming and setting, the result is sectional slat 26, as shown in FIG. 8.

In a modification of the method, an adhesive 82 is inserted between the sheet layers at edge areas 60, 61 in order to adhesively glue the large surfaces of the plural sheet layers.

In the embodiment shown in FIG. 8, a sealing lip 84 is set on one of long edges 28, of second panel element 44 for sealing the outside 42 of roller shutter curtain 14, by having long edge 30 of adjacent sectional slat 26′ contact sealing lip 34.

In the embodiment shown in FIG. 10, a (soft) foamed material 86 is applied to second hinge profile area 56 to seal off the outside. A further soft foam 88 can also be applied—but does not have to be—to the inside of first hinge profile area 54. Soft foam 88 can be injected, for example, by means of an injection needle from the side into the hook profile of first hinge profile area 54.

Three further embodiments of sectional slat 26, 26′ are shown in FIGS. 11 to 13, which unlike the previously explained embodiments, are made by prefabricating each intermediate element 46, then inserting it between panel elements 40, 44 and fixing it there by adhesive gluing by means of an adhesive 90 on panel elements 40, 44.

Herein the same reference numerals are used for comparable parts as in the previously explained embodiments.

In the embodiments shown in FIGS. 11 to 13, folds 65 to 68 have been omitted, although a configuration is conceivable in which a prefabricated intermediate element is inserted into panel elements provided with folds 65 to 68.

In the embodiment shown in FIG. 11 intermediate element 46 is formed by a slat-shaped hard foam pad 92. In the area of long edges 28, 30, hard foam pad 92 is additionally sealed with a water vapor diffusion-tight layer 94.

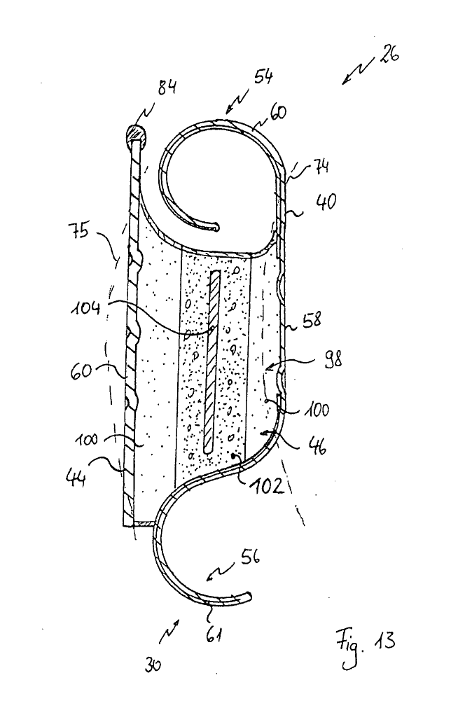

While in the configuration shown in FIG. 11, hard foam pad 92 has homogeneously distributed density, in the embodiment shown in FIG. 12, the density and in particular the strength of intermediate element 46 differs in the direction of the thickness. Instead of hard foam pad 92, a pad of integral foam 96 is used here.

The strength of the pad of integral foam 96 has a bell-shaped distribution as seen across the thickness with a maximum in the middle between the two panel elements 40, 44.

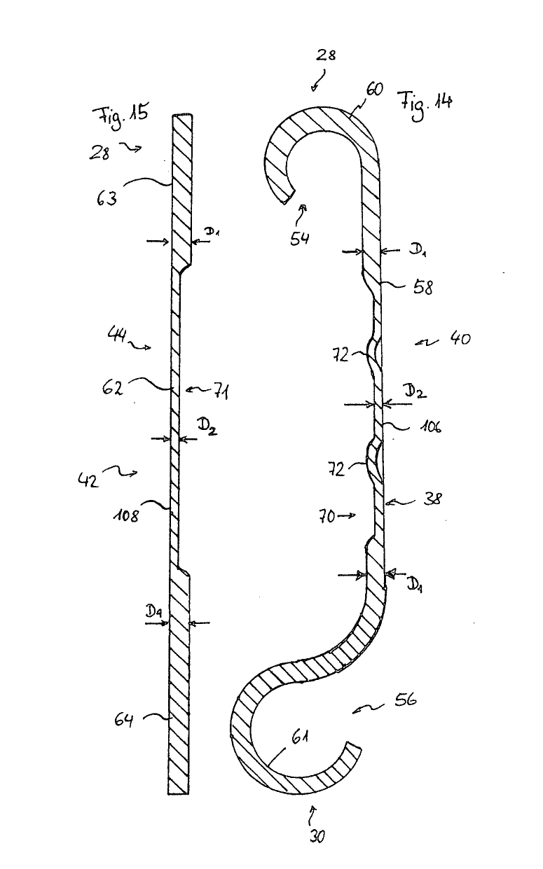

In the embodiment shown in FIG. 13, intermediate element 46 is formed by a pad of composite material 98. The composite material has a layer of less firm foam 100 on each outer face, further to the middle it has a layer of firmer foam 102, and finally a stiffening inlay 104 in the middle. Stiffening inlay 104 could be, for example, of a harder plastic, such as CFK. In the example shown, the stiffening inlay is formed by a metal strip, which is surrounded by the firmer foam 102 on all sides.

In the embodiments according to FIGS. 12 and 13, the water vapor diffusion-tight layer 94 is also provided.

In the embodiments shown in FIGS. 11 to 13, second panel element 44 is only formed to have one layer, wherein metal sheet 52 of second panel element 44 is thicker, however, than metal sheet 58 of first panel element 40. The thickness of metal sheet 62 is smaller by a factor of 1.26 than the thickness of metal sheet 58.

Prefabricated intermediate element 46, according to the embodiments of FIGS. 11 to 13, can be a single strip-shaped pad 96, 98, 100, or can be formed, in a similar manner as shown in FIG. 6 for sectional rib arrangement 50, by shorter pad pieces each densely spaced and arranged one after the other at their end faces.

For further details of how roller shutter 10 can be structured, reference is made to the initially mentioned company publication “Roller Shutters and Roller Grids” of Hörmann AG.

In FIG. 14, an alternative embodiment of first panel element 40 of FIG. 5 is illustrated, wherein, again, the same reference numerals are used to indicate corresponding parts. First panel element 40 of FIG. 14 is distinguished from that of FIG. 5 by having edge areas 60, 61 formed into hinge profile areas 54, 56 not by folding but by providing a greater material thickness. For this purpose, a metal sheet having an initial thickness of D₁ in a central area is rolled by means of narrow rollers to a thinner thickness D₂. Edge areas 60, 61 continue to have thickness D₁ while an intermediate area 106 connecting the edge areas has the thinner material thickness D₂. For example, D₂ is about 0.4 to 0.8 times D₁.

FIG. 15 shows a further embodiment of second panel element 44 thus manufactured with a thinner intermediate area 108 having the material thickness D₂ and thicker edge areas 63, 64 having the material thickness D₁.

The remaining manufacture of the sectional slat is the same as explained previously with reference to FIGS. 3 to 10.

FIG. 16 shows a further embodiment of sectional slat 26, wherein the first panel element only has two layers in the area of hinge profile areas 54, 56, and edge area 60, 61 extends toward the inside while forming part of the narrow top and bottom end sides, and formed with a fold 110 on the end, extending into the interior of sectional slat 26.

Second panel element 44 is formed in a folded-back configuration only at an edge area, wherein edge areas 63 and 64 also extend toward the inside forming a further partial area of the narrow top and bottom end sides. Edge areas 63, 64 are also provided with a comparable fold 112. At lower edge area 64, a groove 114 for sealing lip 84 is also provided.

Sectional rib arrangements 48, 50 are adhesively glued between folds 110, 112 and are of sponge rubber in the present embodiment. The interior between panel elements 40, 44 is, again, filled with foamed material 52—preferably PU foam.

### LIST OF REFERENCE NUMERALS

10 Roller shutter
12 Barrel
14 Roller shutter curtain
16 Guide rail
18 Wall opening
20 Motor drive unit
22 Support brackets
24 Supports
26 Sectional slat
26′ Sectional slat
28 First long edge
30 Second long edge
32 Closing edge
34 Closing edge securing means
36 End section
38 Inside
40 First panel element
42 Outside
44 Second panel element
46 Intermediate element
48 First sectional rib arrangement
50 Second sectional rib arrangement
52 Foamed material
54 First hinge profile area
56 Second hinge profile area
58 First metal sheet
60 Edge area
61 Edge area
62 Second metal sheet
63 Edge area
64 Edge area
65 Fold
66 Fold
67 Fold
68 Fold
70 Inner surface
71 Inner surface
72 Bosses
74 Arc-shaped curve
75 Arc-shaped curve
76 Sectional rib of first sectional rib arrangement
77 Sectional rib of second sectional rib arrangement
78 Space
80 Foamable mass
82 Adhesive
84 Sealing lip
86 (Soft) foamed material
88 Soft foam
90 Adhesive
92 Hard foam pad
94 Water vapor diffusion-tight layer
96 Pad of integral foam
98 Pad of composite material
100 Less firm foam
102 Firmer foam
104 Stiffening inlay
106 Intermediate area
108 Intermediate area
110 Fold
112 Fold
114 Groove

1. A roller shutter curtain sectional slat comprising:
thermal insulation.

2. A sectional slat for a roller shutter curtain, comprising:
a first panel element;
a second panel element; and
at least one intermediate element being arranged between the first and second panel elements,
the material of the at least one intermediate element having poorer thermal conductance than the material of the materials of the panel elements,
at least one of the first and second panel elements having
a first long edge,
a second lone edge being opposed to the first long edge,
a first hinge profile area being formed at the first long edge, and
a second hinge profile area being formed at the second long edge,
the second hinge profile area is at the second long edge being formed in such that the first hinge profile area at the first lone edge combines with the second hinge profile area of an identically formed adjacent sectional slat to form a hinge structure linking the adjacent sectional slats in a hinged manner,
the first and second panel elements being connected to each other only via the at least one intermediate element in a thermally insulated manner.

3. The sectional slat according to claim 2, wherein
the first panel element forms a part of the inside of the roller shutter curtain and/or the second panel element forms a part of the outside of the roller shutter curtain.

4. The sectional slat according to claim 3, wherein
the first panel element has the first and second hinge profile areas at both of its long edges.

5. The sectional slat according to claim 2, wherein
the first and second hinge profile areas have hook-shaped profiles that are complementary to each other.

6. The sectional slat according to claim 5, wherein
at least one of the hook-shaped profiles has a circular arc-shaped profile area.

7. The sectional slat according to claim 2, wherein
the first and second hinge profile areas have a greater wall thickness than an intermediate area of the first panel element connecting the hinge profile areas.

8. The sectional slat according to claim 2, wherein
at least one of the first and second panel elements is made of metal sheeting or of a flatly extending metal section.

9. The sectional slat according to claim 8, wherein
the first panel element having the first and second hinge profile areas is formed of metal sheeting, wherein at least one of the first and second hinge profile areas is formed of at least two sheet layers.

10. The sectional slat according to claim 7, wherein
the panel element having the first and second hinge profile areas is formed of a thicker material or plural metal sheet layers, and is thinner than the other panel element.

11. The sectional slat according to claim 8, wherein
an edge area of the metal sheet is folded back to form the first and second hinge profile areas.

12. The sectional slat according to claim 10, wherein
the plural metal sheet layers are joined over their entire surface or by a plurality of dots welded or adhesively glued together.

13. The sectional slat according to claim 2, wherein
edge areas the first and second panel elements have plural layers or are of a thicker material compared to each intermediate area connecting the edge areas.

14. The sectional slat according to claim 2, wherein
the intermediate element has at least one foamed material.

15. The sectional slat according to claim 2, wherein
the intermediate element has at least one sectional rib as a spacer between the panel elements.

16. The sectional slat according to claim 2, wherein
the intermediate element has at least two sectional rib arrangements spacing the panel elements, and a space between the sectional rib arrangements is filled with foam.

17. The sectional slat according to claim 16, wherein
at least one of the sectional rib arrangements is formed by a plurality of sectional ribs densely spaced in the longitudinal direction.

18. The sectional slat according to claim 15, wherein
the at least one sectional rib made is of a plastic material.

19. The sectional slat according to claim 2, wherein
a surface facing the intermediate element is provided with at least one boss that positively engages the intermediate element, at least on one of the first and second panel elements.

20. The sectional slat according to claim 2, wherein
the intermediate element is formed of at least one prefabricated strip or pad of insulating material adhesively glued to the first and second panel elements.

21. The sectional slat according to claim 20, wherein
the prefabricated pad is a hard foam pad, a pad of integral foam, or a pad of composite material.

22. The sectional slat according to claim 2, wherein
the intermediate element is provided with a barrier layer on exposed surface areas, in particular a water vapour diffusion-tight layer.

23. A roller shutter curtain windable on a barrel, comprising:
a plurality of sectional slats linked to each other according to claim 2.

24. A roller shutter comprising:
a barrel; and
a roller shutter curtain according to claim 23 windable on the barrel.

25. A method for manufacturing a roller shutter sectional slat, comprising:
folding back long edge areas of a first elongate metal sheet, so that multi-layer edge areas result on the long edges or central rolling of the first elongate metal sheet so that thicker edge areas result on the long edges compared to an intermediate area;
forming the multi-layer or thicker edge areas to form hook-shaped hinge profile areas of a first panel element of the final roller shutter sectional slat;
mounting at least two sectional rib arrangements on one surface of the first panel element;
inserting a foamable mass in the space between the sectional rib arrangements;
covering the space with a second panel element;
foaming the foamable mass while exerting a counter pressure from the outside on surface areas of both the first and second panel elements.

26. The method according to claim 25, wherein
forming the sectional rib arrangement by spacing shorter sectional ribs one after the other in the longitudinal direction, until a pair or a series of sectional ribs extends over the entire length of the first panel element.

27. A method for manufacturing a roller shutter sectional slat comprising:
folding back long edge areas of a first elongate metal sheet, so that multi-layer edge areas result on the long edges or central rolling of the first elongate metal sheet so that thicker edge areas result on the long edges compared to an intermediate area;
forming the multi-layer or thicker edge areas to form hook-shaped hinge profile areas to form a first panel element of the final roller shutter sectional slat;
inserting and fixedly joining an intermediate element of insulating material in the or to the first panel element;
fixedly joining the opposing side of the intermediate element to a second panel element.

28. The method according to claim 25, further comprising
folding back the long edge area of a second elongate metal sheet to form the second panel element, and
central rolling of the second elongate metal sheet so that the long edge areas are thicker than the intermediate area connecting the latter before covering the space with a second panel element.

29. The method according to claim 25, further comprising
inserting a foamed material that is softer than the foamable mass in a cavity extending between a hinge profile area of the first panel element, and an opposite long edge area of the second panel element, and a sectional rib arranged further back with respect to the long edges of the panel elements after foaming the foamable mass.
